(19) United States
(12) Patent Application Publication
(10) Pub. No.: US 2015/0362741 A1
(43) Pub. Date: Dec. 17, 2015

(54) STEREOSCOPIC IMAGE DISPLAY APPARATUS

(71) Applicant: Samsung Display Co., Ltd., Yongin-city (KR)

(72) Inventors: SooHee OH, Hwaseong-si (KR); Haeyoung YUN, Suwon-si (KR); Seung Jun JEONG, Hwaseong-si (KR)

(21) Appl. No.: 14/679,472

(22) Filed: Apr. 6, 2015

(30) Foreign Application Priority Data
Jun. 12, 2014 (KR) 10-2014-0071419

(51) Int. Cl. G02B 27/22; G02F 1/1339

(52) U.S. Cl. CPC G02B 27/2214; G02F 1/13394; G02F 2001/13396

(57) ABSTRACT

A stereoscopic image display apparatus includes a display panel including pixels arranged in row and column directions and displaying an image using a light. A switching panel, which controls liquid crystal molecules to allow the image displayed on the display panel to be recognized as a two or three-dimensional image, is disposed on the display panel. The switching panel includes a first substrate, a second substrate facing the first substrate while being coupled to the first substrate, and spacers interposed between the first and second substrates. Each pixel has a first width in the row direction and has a second width in the column direction, and the spacers are arranged in the row direction at a first distance and arranged in the column direction at a second distance. The first distance is different from the first width, and the second width is different from the second distance.

### CROSS-REFERENCE TO RELATED APPLICATION

This application claims priority from and benefit of Korean Patent Application No. 10-2014-0071419, filed on Jun. 12, 2014, which is incorporated by reference for all purposes as if fully set forth herein.

### BACKGROUND

1. Field

Exemplary embodiments of the present disclosure relate to a stereoscopic image display apparatus. More particularly, the present disclosure relates to a stereoscopic image display apparatus capable of improving a display quality of a three-dimensional image.

2. Discussion of Background

An auto-stereoscopic display technology applied to a stereoscopic image display apparatus displays a three-dimensional image without shutter glasses. For auto-stereoscopic display technology, a parallax barrier scheme and a lenticular lens scheme are widely used.

A stereoscopic image display apparatus employing the parallax barrier scheme includes a parallax barrier, through which vertical lattice-shape openings are formed, disposed in front of a display panel including pixels arranged in rows and columns. The parallax barrier separates a right-eye image from a left-eye image with respect to right and left eyes of an observer to generate a binocular disparity in different images.

A stereoscopic image display apparatus employing the lenticular lens scheme includes a lenticular lens sheet having a plurality of semi-cylindrical lenses arranged in the column direction and disposed on the display panel instead of the parallax barrier having a vertical lattice shape.

In particular, an auto-stereoscopic image display apparatus, which includes a switching panel switched between two- and three-dimensional modes, includes two substrates, liquid crystals filled in between the two substrates, and electrodes disposed on one of the substrates to allow the liquid crystals to serve as the lenticular lens shape. The lenticular device is disposed in front of the display panel and switched between two- and three-dimensional modes by turning the voltage applied to the electrodes on and off.

The above information disclosed in this Background section is only for enhancement of understanding of the background of the inventive concept, and, therefore, it may contain information that does not form the prior art that is already known in this country to a person of ordinary skill in the art.

### SUMMARY

Exemplary embodiments of the present disclosure provides a stereoscopic image display apparatus, which includes a display panel and a switching panel stacked on the display panel, capable of improving non-uniformity of brightness.

Exemplary embodiments of the present inventive concept provide a stereoscopic image display apparatus including a display panel comprising pixels arranged in a row direction and a column direction; and a switching panel configured to control liquid crystal molecules of the display panel, such that the display panel produces a two-dimensional image or a three-dimensional image, the switching panel comprising: a first substrate; a second substrate facing the first substrate; and spacers interposed between the first and second substrates, wherein each of the pixels has a first width (Px) in the row direction and a second width (Py) in the column direction, the spacers being spaced apart in the row direction by a first distance (Ax) and in the column direction by a second distance (Ay), wherein the first distance (Ax) is not equal to an integer multiplication of the first width (Px), and the second distance (Ay) is not equal to an integer multiplication of the second width (Py).

Exemplary embodiments of the present inventive concept provide a stereoscopic image display apparatus including: a display panel comprising pixels arranged in a row direction and a column direction; and a switching panel configured to control liquid crystal molecules of the display panel, such that the display panel produces a two-dimensional image or a three-dimensional image, the switching panel comprising: a first substrate; a second substrate facing the first substrate; and spacers interposed between the first and second substrates, wherein each of the pixels has a first width (Px), and a main arrangement direction of the spacers is inclined at a first angle (θ) with respect to the row direction, the spacers being spaced apart in the row direction at a first distance (Ax), wherein the first distance (Ax) satisfies the equation [{(n−1)/2}+0.5]Px<Ax1<[{(n−1)/2}+1]Px, “n” being a natural number equal to or greater than 1.

Exemplary embodiments of the present inventive concept provide a stereoscopic image display apparatus including: a display panel comprising pixels arranged in a row direction and a column direction; and a switching panel configured to control liquid crystal molecules of the display panel, such that the display panel produces a two-dimensional image or a three-dimensional image, the switching panel comprising: a first substrate; a second substrate facing the first substrate; and spacers interposed between the first and second substrates, wherein each of the pixel has a first width (Px) in the row direction and a second width (Py) in the column direction, the spacers being randomly spaced apart in a unit area, wherein the unit area (A1) satisfies the equation A1≧100(Px·Py).

According to the above, an arrangement period of the pixels of the display panel is different from an arrangement period of the spacers of the switching panel disposed on the display panel. Thus, non-uniformity of the brightness, e.g., a moiré phenomenon, which occurs between the display panel and the switching panel by a beat phenomenon, may be improved.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain principles of the inventive concept.

The above and other advantages of the present disclosure will become readily apparent by reference to the following detailed description when considered in conjunction with the accompanying drawings.

FIGS. 1 and 2 are views showing a method of forming two- and three-dimensional images of a stereoscopic image display apparatus according to an exemplary embodiment of the present disclosure.

FIG. 3 is a cross-sectional view showing a stereoscopic image display apparatus according to an exemplary embodiment of the present disclosure.

FIG. 4 is an exploded perspective view showing a switching panel shown in FIG. 3.

FIG. 5 is a plan view showing a corresponding relation between spacers and pixels according to an exemplary embodiment of the present disclosure.

FIG. 6 is a plan view showing a corresponding relation between spacers and pixels according to an exemplary embodiment of the present disclosure.

FIG. 7 is a plan view showing a corresponding relation between spacers and pixels according to an exemplary embodiment of the present disclosure.

FIG. 8 is a view showing brightness uniformity according to a second angle between a second main arrangement direction and a row direction and a third distance.

FIG. 9 is a plan view showing an arrangement structure of spacers in a switching panel according to another exemplary embodiment of the present disclosure.

FIG. 10 is a graph showing brightness uniformity according to a size of unit area shown in FIG. 9.

FIG. 11 is a cross-sectional view showing a switching panel according to another exemplary embodiment of the present disclosure.

FIG. 12 is a plan view showing an arrangement relation between main spacers and sub-spacers according to an exemplary embodiment of the present disclosure.

FIG. 13 is a plan view showing an arrangement relation between main spacers and sub-spacers according to another exemplary embodiment of the present disclosure.

FIG. 14 is a plan view showing an arrangement relation between main spacers and sub-spacers according to another exemplary embodiment of the present disclosure.

FIG. 15 is a plan view showing an arrangement relation between main spacers and sub-spacers according to another exemplary embodiment of the present disclosure.

FIG. 16 is a plan view showing an arrangement relation between main spacers and sub-spacers according to another exemplary embodiment of the present disclosure.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of layers, films, panels, regions, etc., may be exaggerated for clarity and descriptive purposes. Also, like reference numerals denote like elements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

Hereinafter, exemplary embodiments of the present invention will be explained in detail with reference to the accompanying drawings.

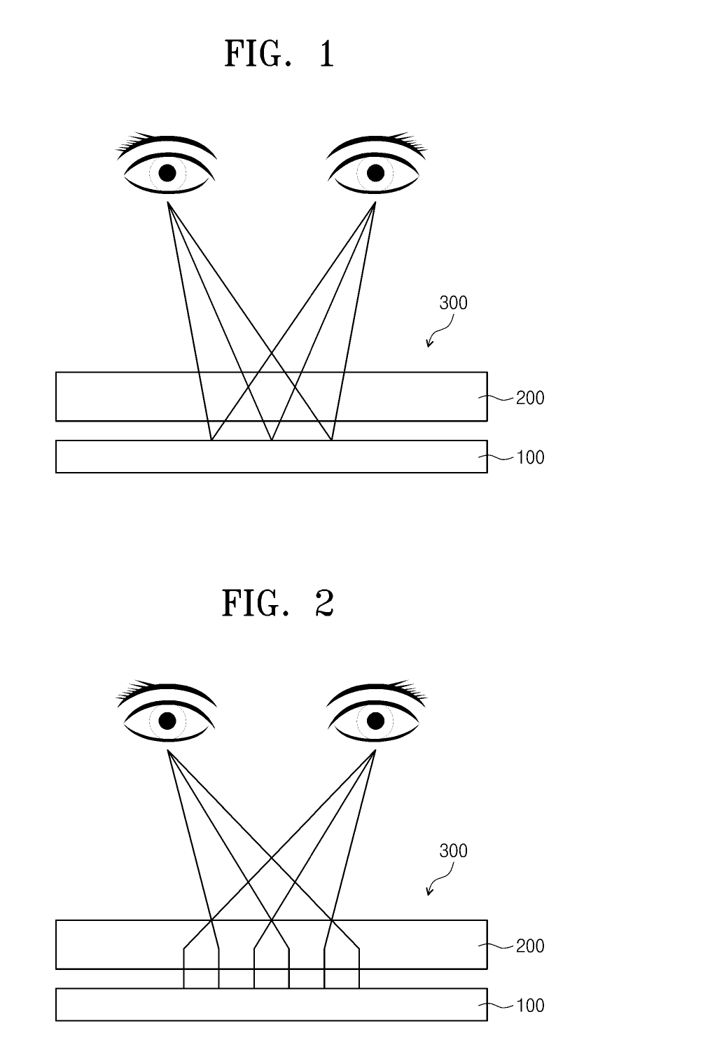

FIGS. 1 and 2 are views showing a method of forming two- and three-dimensional images of a stereoscopic image display apparatus according to an exemplary embodiment of the present disclosure.

Referring to FIGS. 1 and 2, the stereoscopic image display apparatus 300 includes a display panel 100 to display an image and a switching panel 200 disposed in on the display panel 100, on which the image is displayed. The display panel 100 and the switching panel 200 may be operated in a two or three-dimensional (2D or 3D) mode.

Although not shown in the figures, the display panel 100 includes a plurality of pixels arranged in a matrix form to display an image. The display panel 100 displays one plane image in the 2D mode, but alternately displays images corresponding to various visual fields, such as a right-eye image, a left-eye image, etc., through spatial- and time-division-multiplexing schemes in the 3D mode. For instance, the display panel 100 alternately displays the right-eye image and the left-eye image per each pixel in one column during the 3D mode.

The switching panel 200 transmits the image displayed in the display panel 100 during the 2D mode without separation in the visual field. Whereas, the switching panel 200 separates the visual field of the image displayed in the display panel 100 during the 3D mode. That is, the switching panel 200 operating in the 3D mode allows a multi-viewpoint image including the left-eye image and the right-eye image, which are displayed in the display panel 100, to fall on a corresponding visual field in each viewpoint by using refraction and diffraction of the light.

FIG. 1 shows the display panel 100 and the switching panel 200, which are operated in the 2D mode. In this case, the same image is transmitted to left and right eyes of an observer, and thus the observer recognizes a 2D image. FIG. 2 shows the display panel 100 and the switching panel 200, which are operated in the 3D mode. During the 3D mode, the switching panel 200 separates the image in each visual field as the left and right eyes' images and refracts the images, to allow the observer to recognize a 3D image.

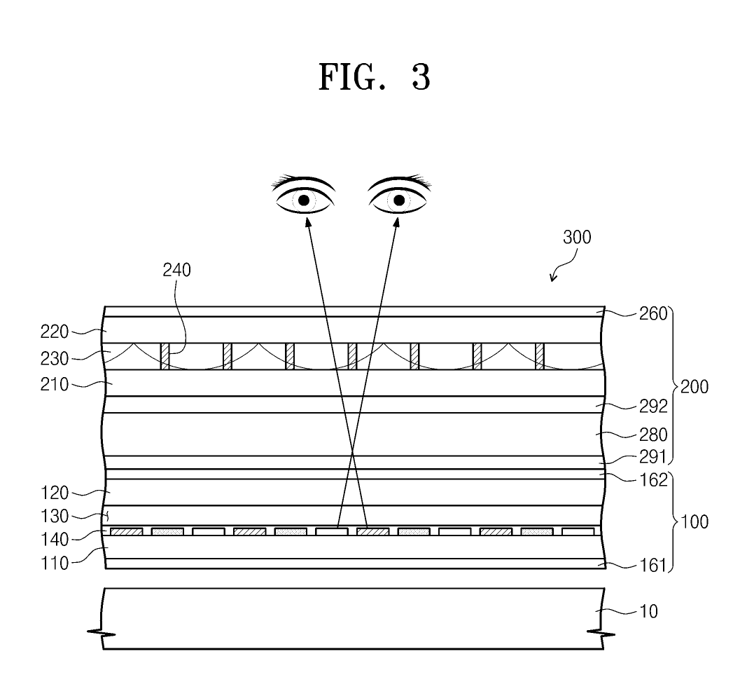

FIG. 3 is a cross-sectional view showing a stereoscopic image display apparatus 300 according to an exemplary embodiment of the present disclosure.

Referring to FIG. 3, the stereoscopic image display apparatus 300 includes a backlight unit 10, the display panel 100, and the switching panel 200.

The display panel 100 may be a liquid crystal display panel including a pixel array 140 in which the pixels are arranged in rows and columns. The display panel 100 may also be one of the various display panels, e.g., an organic electroluminescent display panel, an electrophoretic display panel, etc.

The display panel 100 includes a first display substrate 110, a second display substrate 120 facing the first display substrate 110, and a liquid crystal layer 130 interposed between the first display substrate 110 and the second display substrate 120.

The pixel array 140 is disposed on the first display substrate 110 and includes pixel electrodes. The pixel electrodes are arranged in a matrix form. Although not shown in the figures, the pixel array 140 may further include gate lines extending in a row direction on the first display substrate 110, data lines extending in a column direction on the first display substrate 110, and thin film transistors connected to each of the corresponding pixel electrodes.

The pixel array 140 may further include a color filter layer including red, green, and blue color pixels. The pixel electrodes may be disposed on each of the corresponding color filter layer to correspond to the color pixels.

The liquid crystal layer 130 includes a plurality of liquid crystal molecules which are aligned in a direction controlled by an electric field formed between the first and second display substrates 110 and 120.

The display panel 100 further includes a first polarizer 161 and a second polarizer 162, which are respectively attached to a lower surface of the first display substrate 110 and an upper surface of the second display substrate 120.

The switching panel 200 may be switched from the 2D mode to the 3D mode, or vice versa. The switching panel 200 is turned on or turned off to change a driving mode of the stereoscopic image display apparatus 300. In particular, when the switching panel 200 is turned on, the 2D image exiting from the display panel 100 is converted to the 3D image while transmitted through the turned-on switching panel 200. Accordingly, the stereoscopic image display apparatus 300 is operated in the 3D mode. On the contrary, when the switching panel 200 is turned off, the 2D image exiting from the display panel 100 transmits through the switching panel 200 without being converted. In this case, the stereoscopic image display apparatus 300 is operated in the 2D mode.

The switching panel 200 could include, for example, a first substrate 210 and a second substrate 220 facing the first substrate 210. A lower electrode (not shown) is disposed on the first substrate 210 and an upper electrode (not shown) is disposed on the second substrate 220. One of the upper and lower electrodes may be integrally formed as a single unitary and individual unit to cover the entire surface of the substrate, and the other of the upper and lower electrodes may include electrodes extending in one direction. The electrodes are substantially in parallel to each other and spaced apart from each other at regular intervals.

The switching panel 200 may further include a liquid crystal lens layer 230 and spacers 240, which are interposed between the first and second substrates 210 and 220. The liquid crystal lens layer 230 may include a twisted nematic liquid crystal. The liquid crystal may be, but is not limited to, a white liquid crystal. The spacers 240 are disposed between the first and second substrates 210 and 220 to maintain a distance between the first and second substrates 210 and 220.

The switching panel 200 further includes a third polarizer 260 disposed on the second substrate 220 and a distance maintaining substrate 280 disposed between the first substrate 210 and the second polarizer 162. The distance maintaining substrate 280 may be formed of a transparent glass or plastic and may have a thickness sufficient to maintain a lens focal length between lenses formed by the liquid crystal lens layer 230 and the pixels of the display panel 150.

A lower surface of the distance maintaining substrate 280 may be attached to an upper surface of the second polarizer 162 using a first optical adhesive 291 and an upper surface of the distance maintaining substrate 280 may be attached to the lower surface of the first substrate 210 using a second optical adhesive 292. The distance maintaining substrate 280 and the first and second optical adhesives 291 and 292 may include an optical transparent material, such that the first and second display substrates 110 and 120 have the same refractive index as that of the first and second substrates 210 and 220.

The backlight unit 10 is disposed at the lower surface of the first polarizer 161 and generates light. The backlight unit 10 may include a light emitting diode or a cold cathode fluorescent lamp as its light source. Light generated by the backlight unit 10 is polarized by the first polarizer 161, and thus, only light component with vibration direction substantially parallel to a first polarizing axis of the first polarizer is supplied to the first display substrate 110.

Although not shown in figures, the stereoscopic image display apparatus 300 displays the image thereon during an image display mode, but it has a transparent property to allow an observer to recognize objects disposed at the rear side of the stereoscopic image display apparatus 300 or backgrounds of the stereoscopic image display apparatus 300 during an off mode.

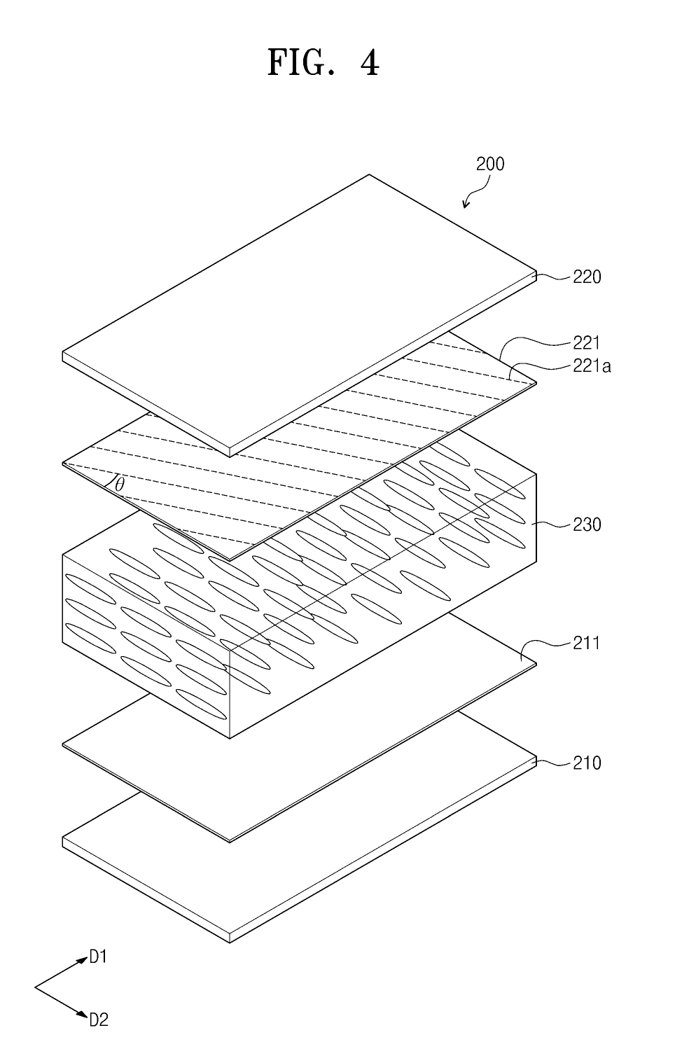

FIG. 4 is an exploded perspective view showing the switching panel 200 shown in FIG. 3.

Referring to FIG. 4, the switching panel 200 may include the first substrate 210, the second substrate 220 facing the first substrate 210, and the liquid crystal lens layer 230 interposed between the first substrate 210 and the second substrate 220. As shown in FIG. 3, the switching panel 200 includes the spacers 240 which are not shown in FIG. 4.

Each of the first and second substrates 210 and 220 is a plate that may be made of a transparent glass or plastic material, and the lower electrode 211 and the upper electrode 221 are respectively disposed on the first and second substrates 210 and 220.

The lower electrode 211 is formed by depositing a transparent conductive material, e.g., indium tin oxide, indium zinc oxide, etc., on the entire surface of the upper surface of the first substrate 210. The upper electrode 221 is formed on the lower surface of the second substrate 220 and includes the electrodes 221a each having a stripe shape. The electrodes 221a are substantially parallel to each other and spaced apart from each other at regular intervals. The electrodes 221a are formed by patterning a transparent electrode layer, e.g., indium zinc oxide, indium tin oxide, etc., using a photolithography process.

In the present exemplary embodiment, a direction substantially parallel to longer side of the first and second substrates 210 and 220 is referred to as a row direction D1 and a direction substantially parallel to shorter side of the first and second substrates 210 and 220 is referred to as a column direction D2, as shown in FIG. 4. The electrodes 221a extend in a direction inclined at an angle (θ) with respect to the column direction D2.

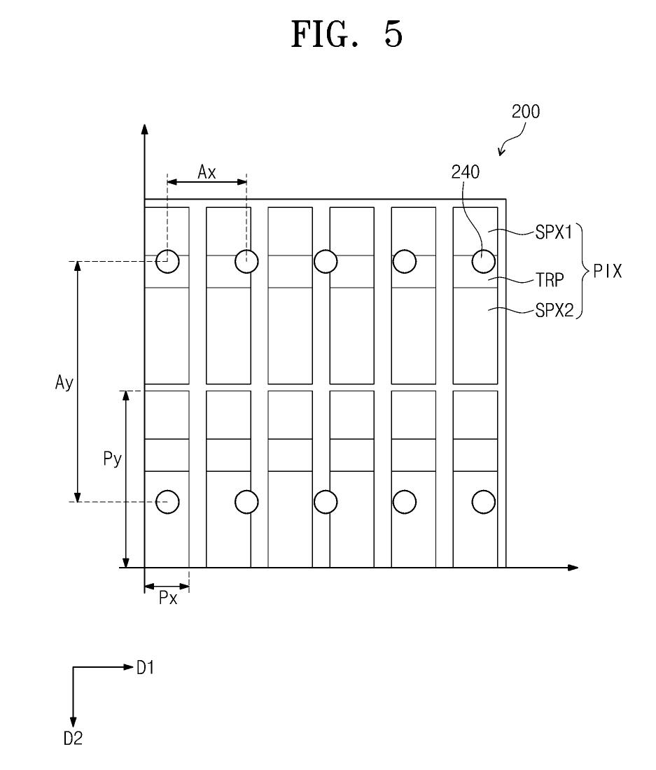

FIG. 5 is a plan view showing a corresponding relation between spacers and pixels according to an exemplary embodiment of the present disclosure.

Referring to FIG. 5, the pixels PIX are arranged in the D1 and D2 directions, where D1 corresponds to the row direction and D2 corresponds to the column direction, on the display panel 100. The pixels PIX have the same size. Therefore, each pixel PIX has a first width Px in the row direction D1 and a second width Py in the column direction D2.

Each pixel PIX includes a first sub-pixel part SPX1 and a second sub-pixel part SPX2. The first and second sub-pixel parts SPX1 and SPX2 are applied with different data voltages. The first sub-pixel part SPX1 displays the image having a relatively high gray scale and the second sub-pixel part SPX2 displays the image having a relatively low gray scale. The second sub-pixel part SPX2 has a size greater than that of the first sub-pixel part SPX1.

Each pixel PIX further includes a transistor part TRP in which transistors used to drive the first and second sub-pixel parts SPX1 and SPX2 are arranged. A number of the transistors in the transistor part TRP is determined depending on a driving scheme of each pixel PIX, e.g., a coupling capacitor scheme, a resistive division scheme, etc.

The transistor part TRP is disposed between the first and second sub-pixel parts SPX1 and SPX2.

The spacers 240 of the switching panel 200 are arranged in the row direction D1 at a first distance Ax and arranged in the column direction D2 at a second distance Ay. The first distance Ax has a value different from an integer multiplication of the first width Px and the second distance Ay has a value different from an integer multiplication of the second width Py.

As an example, the first distance Ax may be smaller than the first width Px and the second distance Ay may be smaller than the second width Py. In this case, the first distance Ax satisfies the following Equation 1, and the second distance Ay satisfies the following Equation 2.

0.35Px≦Ax≦0.75Px Equation 1:

0.35P≦Ay≦0.75Py Equation 2:

As another example, the first distance Ax may satisfy the following Equation 3 and the second distance Ay may satisfy the following Equation 4.

0.65Px≦Ax≦0.75Px Equation 3:

0.65Py≦Ay≦0.75Py Equation 4:

As another example, the first distance Ax may be greater than the first width Px and the second distance Ay may be greater than the second width Py. In this case, the first distance Ax satisfies the following Equation 5 and the second distance Ay satisfies the following Equation 6.

1.35Px≦Ax Equation 5:

1.35Py≦Ay Equation 6:

As shown in FIG. 5, each spacer 240 has a circular shape when viewed in a plan view, but it should not be limited to a circular shape. That is, each spacer 240 may have, for example, a quadrangular shape, a triangular shape, or an oval shape.

In addition, the spacers 240 are arranged in the row direction D1 to be equally spaced apart from each other, but the distance in the row direction D1 between the spacers 240 may vary within the range of the first distance Ax.

Further, the spacers 240 are arranged in the column direction D2 to be equally spaced apart from each other, but the distance in the column direction D1 between the spacers 240 may vary within the range of the second distance Ay.

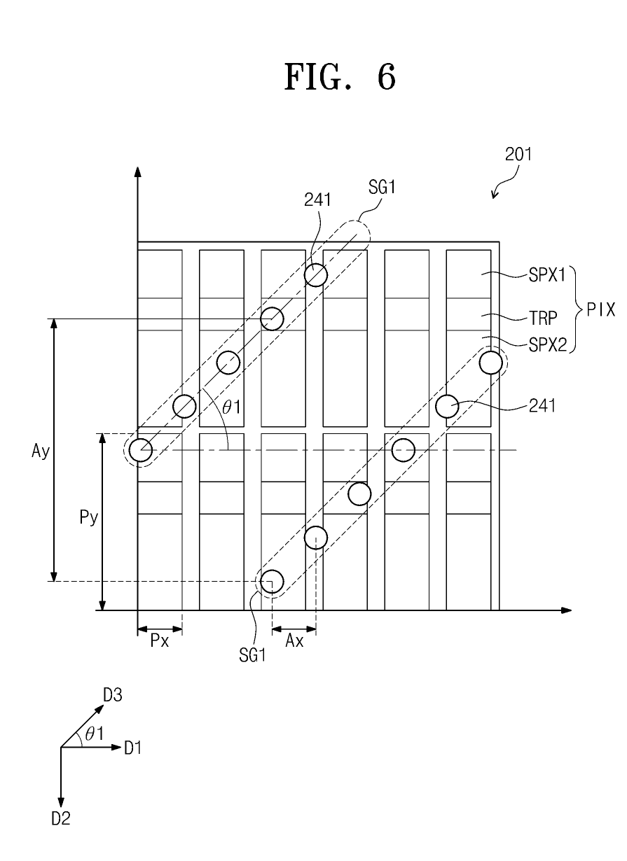

FIG. 6 is a plan view showing a corresponding relation between spacers and pixels according to an exemplary embodiment of the present disclosure.

Referring to FIG. 6, a switching panel 201 may include a plurality of first spacer groups SG1. Each of the first spacer groups SG1 includes spacers 241 arranged in a direction inclined at a first angle θ1 with respect to the row direction D1. Here, the direction inclined at the first angle θ1 is referred to as a first main arrangement direction D3 of the spacers 241. The first spacer groups SG1 are arranged in the row direction D1 and spaced apart from each other.

As an example, the first angle θ1 may satisfy the following Equation 7.

40°≦|θ1≦70° Equation 7:

The spacers 241 may be arranged in the row direction D1 at a first distance Ax and arranged in the column direction D2 at a second distance Ay. In this case, the first distance Ax satisfies the following Equation 8 and the second distance Ay satisfies the following Equation 9.

Ax≦Px·cos θ Equation 8:

Ay≦Py·cos θ Equation 9:

In Equations 8 and 9, “Px” denotes a first width in the row direction D1 of each is pixel PIX and “Py” denotes a second width in the column direction D2 of each pixel PIX.

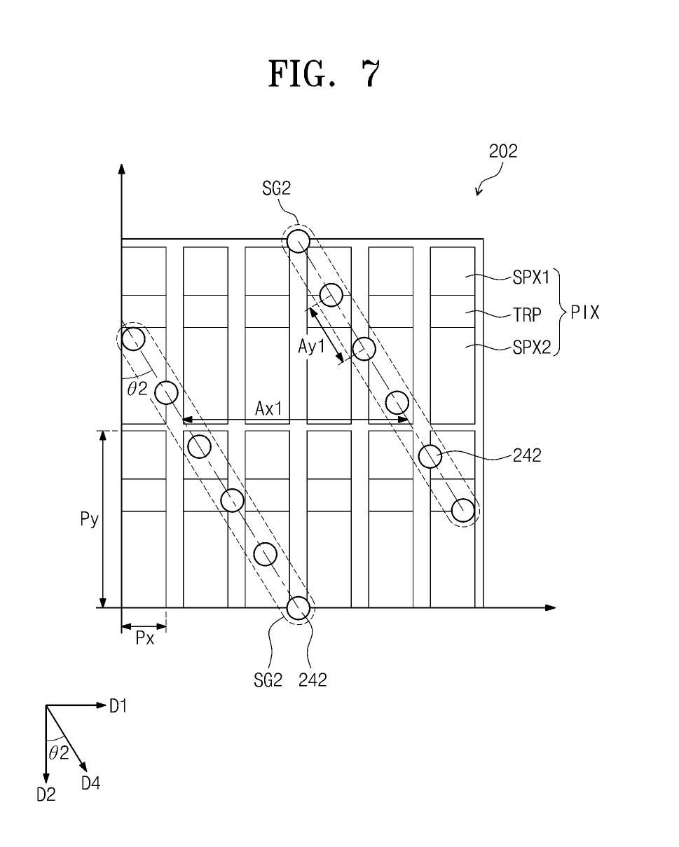

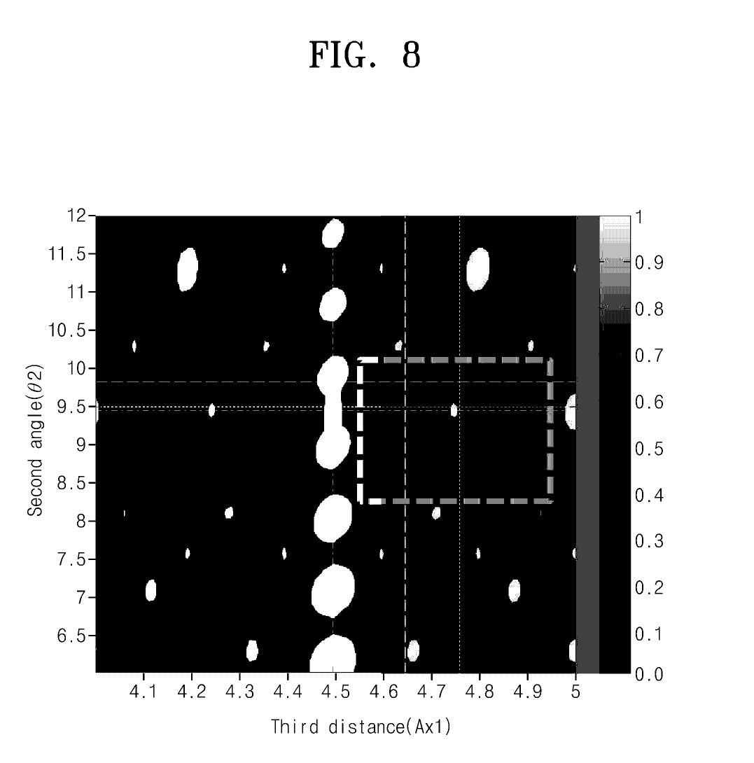

FIG. 7 is a plan view showing a corresponding relation between spacers and pixels according to an exemplary embodiment of the present disclosure, and FIG. 8 is a view showing brightness uniformity according to a second angle between a second main arrangement direction and a row direction D1 and a third distance.

Referring to FIG. 7, a switching panel 202 may include a plurality of second spacer groups SG2. Each of the second spacer groups SG2 includes spacers 242 arranged in a direction inclined at a second angle θ2 with respect to the column direction D2. Here, the direction inclined at the second angle θ2 is referred to as a second main arrangement direction D4 of the spacers 242. The second spacer groups SG2 may be arranged in the row direction D1 and spaced apart from each other.

In this case, the second spacer groups SG2 arranged in the row direction D1 are spaced apart from one another at a third distance Ax1.

The third distance A1 satisfies the following Equation 10.

[{(n−1)/2}+0.5]Px<Ax1<[{(n−1)/2}+1]Px Equation 10:

In Equation 10, “n” is a natural number equal to or larger than 1 and “Px” denotes a width in the row direction D1 of each pixel PIX of the display panel 100.

The “n” indicates the number of viewpoints displayed by the switching panel 202. For instance, when the switching panel 202 displays nine viewpoints, the third distance Ax1 is set to a value within a range from about 4.5 (Px) to approximately 5 (Px).

The second angle θ2 satisfies the following Equation 11.

8°≦|θ2|≦10° Equation 11:

When a distance between the spacers 242 in the second main arrangement direction D4 is referred to as a fourth distance Ay1, the fourth distance Ay1 varies depending on a target density of the spacers 242 in the switching panel 202.

Referring to FIG. 8, when the display panel 100 displays a black gray scale and the third distance Ax1 between the second spacer groups SG2 of the switching panel 202 is about 4.5, there are multiple areas having a relatively high brightness. That is, the h uniformity in brightness measured when the third distance Ax1 is greater than 4.5 and smaller than 5 is better than the uniformity in brightness measured when the third distance Ax1 is 4.5.

In addition, when an inclination angle, i.e., the second angle θ2, between the second main arrangement direction D4 and the row direction D1 is greater than 8 degrees and smaller than 10 degrees, a white area having the relatively high brightness almost does not exist, and thus the brightness uniformity is improved.

As described above, to improve the brightness uniformity when the second spacer groups SG2 are arranged, the third distance Ax1 may be set to be greater than 4.5 and smaller than 5 and the second angle θ2 may be set to be greater than 8 degrees and smaller than 10 degrees.

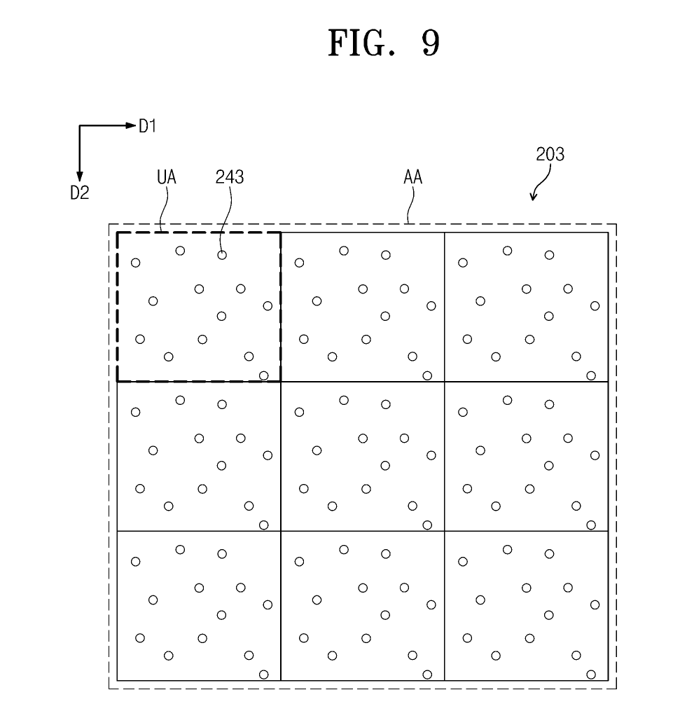

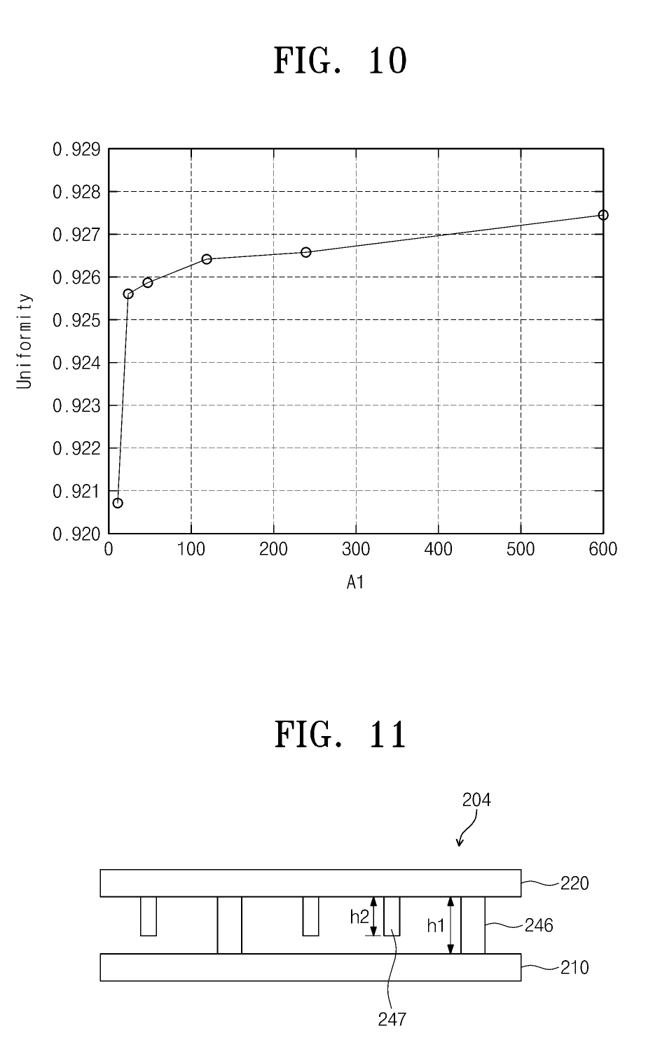

FIG. 9 is a plan view showing an arrangement structure of spacers in a switching panel according to an exemplary embodiment of the present disclosure and FIG. 10 is a graph showing brightness uniformity according to a size of unit area shown in FIG. 9.

Referring to FIG. 9, a switching panel 203 may include an effective display area AA defined therein. The effective area AA includes a plurality of unit areas UA arranged in the effective display area AA in a matrix form. Each unit area UA includes spacers 243. The spacers 243 may be randomly arranged in each unit area UA. The spacers 243 may also be arranged in the same pattern in each unit area UA. That is, a random period in the row direction D1 of the spacers 243 may be the horizontal width of each unit area UA and a random period in the column direction D2 may be the vertical width of each unit area UA. In addition, the spacers 243 may be arranged in the same density in each unit area UA.

The size A1 of each unit area UA may satisfy the following Equation 12.

A1≧100(Px·Py) Equation 12:

In Equation 12, “Px” denotes a width in the row direction D1 of each pixel PIX of the display panel 100 (refer to FIG. 3) and “Py” denotes a width in the column direction D2 of each pixel PIX.

According to Equation 12, each of the unit areas UA has the size A1 that is about one hundred times greater than the size (Px×Py) of each pixel PIX.

In FIG. 10, the x-axis indicates the size A1 of each unit area UA and the y-axis indicates the brightness uniformity.

Referring to FIG. 10, when the size A1 of each unit area UA is smaller than one hundred times the size (Px×Py) of each pixel PIX, the brightness uniformity is reduced. However, when the size A1 of each unit area UA is equal to or greater than about one hundred times the size (Px×Py) of each pixel PIX, the value of the brightness uniformity is approximately 0.926.

FIG. 11 is a cross-sectional view showing a switching panel according to an exemplary embodiment of the present disclosure.

Referring to FIG. 11, a switching panel 204 includes main spacers 246 and sub-spacers 247, which are disposed between the first and second substrates 210 and 220. For the convenience of explanation, the other elements of the switching panel 204 will be omitted in FIG. 11 except for the first substrate 210, the second substrate 220, and the main and sub-spacers 246 and 247.

The main spacers 246 have a first height h1 and the sub-spacers 247 have a second height h2 shorter than the first height h1. The main spacers 246 have a width equal to or greater than that of the sub-spacers 247.

The main and sub-spacers 246 and 247 are disposed on one of the first and second substrates 210 and 220. When the main and sub-spacers 246 and 247 are disposed on the second substrate 220, the main spacers 246 make contact with the first substrate 210 and the sub-spacers 247 are spaced apart from the first substrate 210 by a predetermined distance.

Since the main spacers 246 are formed of a material with elasticity, the height h1 of the main spacers 246 decreases when external force is applied to the first and second substrates 210 and 220. Accordingly, a reference cell gap between the first and second substrates 210 and 220 is temporarily decreased. Then, when the external force disappears, the first and second substrates 210 and 220 return to their original positions due to a restoring force of the main spacers 246.

However, when the external force applied to the first and second substrates 210 and 220 is greater than the elastic force of the main spacers 246, the first and second substrates 210 and 220 may not return to their original positions. As a result, the cell gap of the switching panel 204 may not be maintained at the reference cell gap. The sub-spacers 247 buffer the external force applied to the main spacers 246, and thus, the sub-spacers 247 prevent the elasticity of the main spacers 246 from deteriorating due to the external force.

In addition, the number of the main spacers 246 may be smaller than the number of the sub-spacers 247 in the switching panel 204.

As an example, an area ratio of the main spacers 246 to the effective display area AA (refer to FIG. 9) of the switching panel 204 may be equal to or greater than about 0.15%. The area ratio indicates a ratio of a sum of contact areas between the main spacers 246 and the second substrate 220 to the effective display area AA of the switching panel 204. As the area ratio of the main spacers 246 becomes high, the brightness uniformity is reduced. On the contrary, when the area ratio of the main spacers 246 is smaller than about 0.15%, non-uniformity in brightness does not occur. Therefore, when the area ratio of the main spacers 246 is equal to or greater than about 0.15%, the main spacers 246 and the sub-spacers 247 may be arranged in the same way as shown in FIGS. 5 to 10, so that the brightness uniformity may be improved.

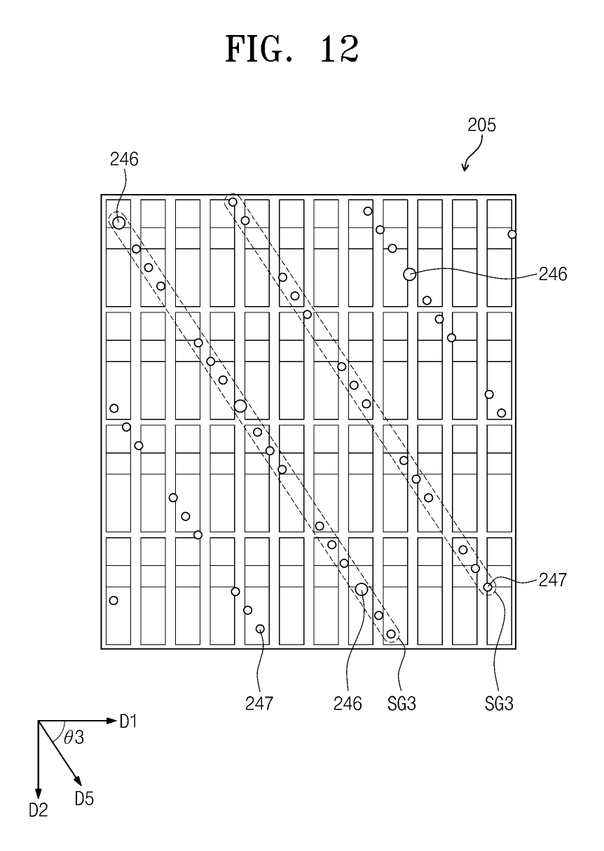

FIG. 12 is a plan view showing an arrangement relation between main spacers and sub-spacers according to an exemplary embodiment of the present disclosure.

Referring to FIG. 12, a switching panel 205 may include a plurality of third spacer groups SG3. Each of the third spacer groups SG3 is inclined at a third angle θ3 with respect to the row direction D1, and the third spacer groups SG3 are repeatedly arranged in the row direction D1. The direction inclined at the third angle θ3 with respect to the row direction D1 is referred to as a third main arrangement direction D5.

Each of the third spacer groups SG3 may further include main spacers 246 arranged in the third main arrangement direction D5 and sub-spacers 247 disposed between the main spacers 246 and arranged in the third main arrangement direction D5.

As an example, the third angle θ3 may be, but not limited to, about −54 degrees. An absolute value of the third angle θ3 is included in the range represented by the Equation 9.

Among the sub-spacers 247 included in each of the third spacer groups SG3, a distance in the row direction and a distance in the column direction between at least two sub-spacers satisfy the Equations 7 and 8, respectively.

As described above, when the third spacer groups SG3 are inclined at the third angle θ3 included in the range represented by the Equation 9, a moiré phenomenon does not occur.

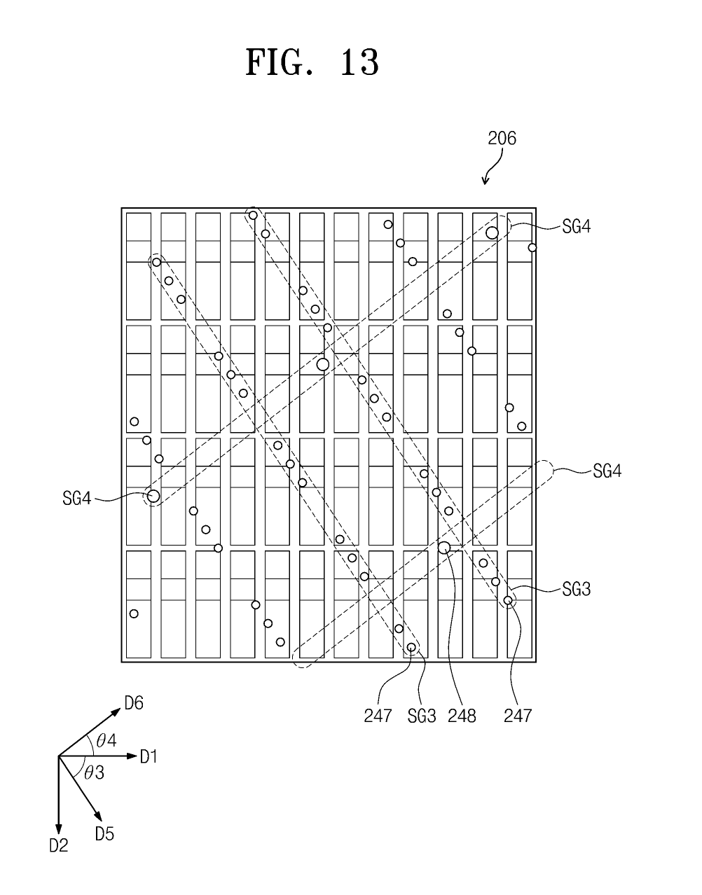

FIG. 13 is a plan view showing an arrangement relation between main spacers and sub-spacers according to an exemplary embodiment of the present disclosure.

Referring to FIG. 13, a switching panel 206 may include a plurality of third spacer groups SG3 and a plurality of fourth spacer groups SG4. Each of the third spacer groups SG3 includes sub-spacers 247 arranged in the third main arrangement direction D5 inclined at a third angle θ3 with respect to the row direction D1. Each of the fourth spacer groups SG4 includes main spacers 246 arranged in a fourth main arrangement direction D6 inclined at a fourth angle θ4 with respect to the row direction D1.

As an example, the third angle θ3 may be, but not limited to, about −54 degrees, and the fourth angle θ4 may be, but not limited to, about +36 degrees.

Among the sub-spacers 247 included in each of the third spacer groups SG3, a distance in the row direction and a distance in the column direction between at least two sub-spacers satisfy the Equations 7 and 8, respectively.

As described above, when the third and fourth spacer groups SG3 and SG4 are inclined at the third and fourth angles θ3 and θ4 included in the range represented by the Equation 9, the moiré phenomenon does not occur.

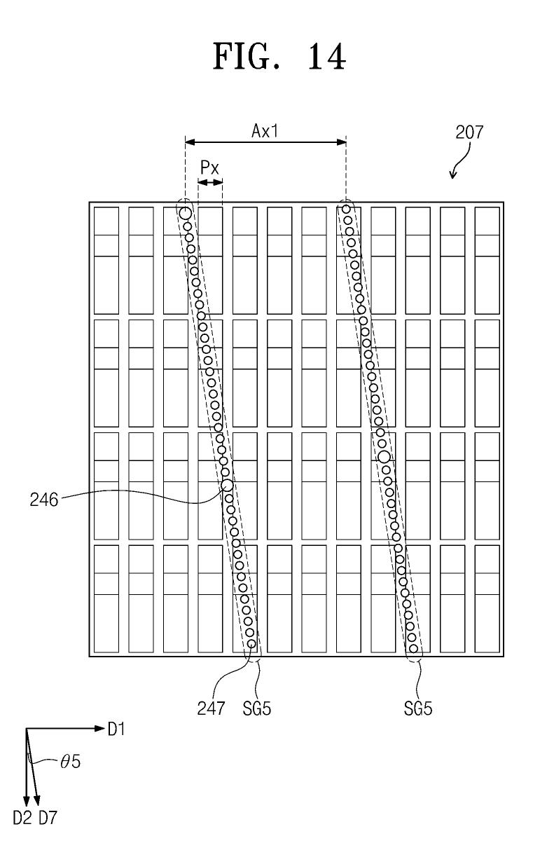

FIG. 14 is a plan view showing an arrangement relation between main spacers and sub-spacers according to another exemplary embodiment of the present disclosure.

Referring to FIG. 14, a switching panel 207 may include a plurality of fifth spacer groups SG5. Each of the fifth spacer groups SG5 is inclined at a fifth angle 05 with respect to the column direction D2 and repeatedly arranged in the row direction D1 by the third distance Ax1. The direction inclined at the fifth angle θ5 with respect to the column direction D2 is referred to as a fifth main arrangement direction D7.

Each of the fifth spacer groups SG5 may further include main spacers 246 arranged in the fifth main arrangement direction D7 and sub-spacers 247 disposed between the main spacers 246 and arranged in the fifth main arrangement direction D7. As an example, the fifth angle θ5 may be greater than about 8 degrees and smaller than 10 degrees, which is represented by the Equation 11.

The fifth spacer groups SG5 are arranged in the row direction D1 and spaced apart from one another by the third distance Ax1. When the switching panel 207 displays nine viewpoints, the third distance Ax1 is set to the range from about 4.5 (Px) to about 5 (Px).

As described above, when the fifth spacer groups SG5 are inclined at the fifth angle θ5 included in the range represented by the Equation 11, the moiré phenomenon does not occur.

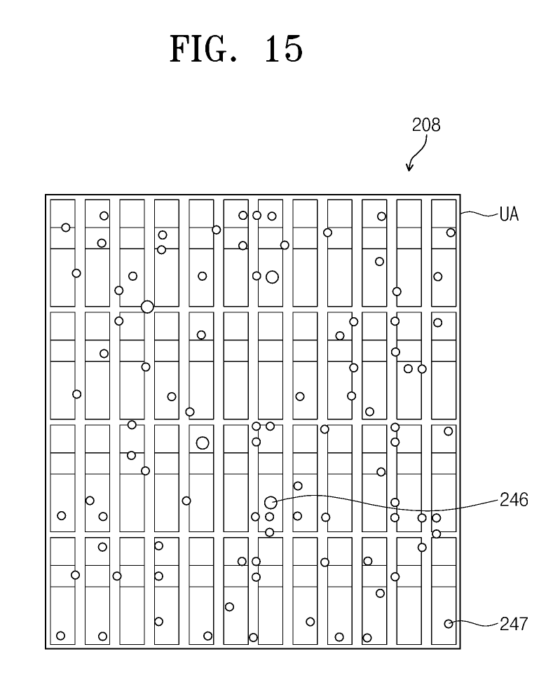

FIG. 15 is a plan view showing an arrangement relation between main spacers and sub-spacers according to another exemplary embodiment of the present disclosure.

Referring to FIG. 15, each unit area UA of a switching panel 208 may include main spacers 246 and sub-spacers 247. The main spacers 246 and the sub-spacers 247 may be randomly arranged in each unit area UA. The random period of the main spacers 246 and the sub-spacers 247 may be, but not limited to, one unit area UA.

The density of the main spacers 246 may be different from the density of the sub-spacers 247 in each unit area UA.

When the size A1 of each unit area UA is included in the range represented by the Equation 12, the moiré phenomenon does not occur.

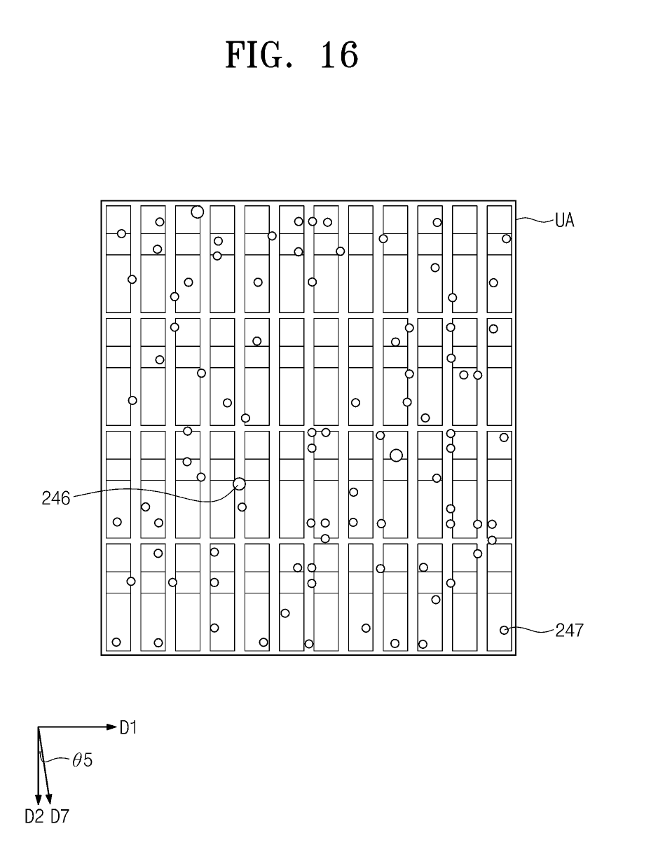

FIG. 16 is a plan view showing an arrangement relation between main spacers and sub-spacers according to an exemplary embodiment of the present disclosure.

Referring to FIG. 16, each unit area UA may include main spacers 246 and sub-spacers 247. The sub-spacers 247 may be randomly arranged in each unit area UA.

The main spacers 246 are arranged in a fifth main arrangement direction D7 inclined at a fifth angle θ5 with respect to the column direction D2. In addition, the main spacers 246 are arranged in the row direction D1 and spaced apart from one another by the third distance Ax1.

The main spacers 246 shown in FIG. 16 may be arranged in the same way as the main spaces 246 shown in FIG. 14, and the sub-spacers 247 shown in FIG. 16 may be randomly arranged in the same way as the sub-spacers 247 shown in FIG. 15.

As described above, although the main and sub-spacers 246 and 247 are arranged in different ways, the moiré phenomenon does not occur.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A three-dimensional image display apparatus comprising:
a display panel comprising pixels arranged in a row direction and a column direction; and
a switching panel configured to control liquid crystal molecules of the display panel, such that the display panel produces a two-dimensional image or a three-dimensional image, the switching panel comprising:
a first substrate;
a second substrate facing the first substrate; and
spacers interposed between the first and second substrates, wherein each of the pixels has a first width (Px) in the row direction and a second width (Py) in the column direction, the spacers being spaced apart in the row direction by a first distance (Ax) and in the column direction by a second distance (Ay),
wherein the first distance (Ax) is not equal to an integer multiplication of the first width (Px), and the second distance (Ay) is not equal to an integer multiplication of the second width (Py).

2. The three-dimensional image display apparatus of claim 1, wherein:
the first distance (Ax) is less than the first width (Px);
the second distance (Ay) is less than the second width (Py);
the first distance (Ax) satisfies the equation 0.35Px≦Ax≦0.75Px; and
the second distance (Ay) satisfies the equation 0.35Py≦Ay≦0.75Py.

3. The three-dimensional image display apparatus of claim 2, wherein:
the first distance (Ax) satisfies the equation 0.65Px≦Ax≦0.75Px; and
the second distance (Ay) satisfies the equation 0.65Py≦Ay>0.75Py.

4. The three-dimensional image display apparatus of claim 1, wherein:
the first distance (Ax) is greater than the first width (Px);
the second distance (Ay) is greater than the second width (Py);
the first distance (Ax) satisfying the equation 1.35Px≦Ax; and
the second distance (Ay) satisfying the equation 1.35Py≦Ay.

5. The three-dimensional image display apparatus of claim 1, wherein a main arrangement direction of the spacers is inclined at a first angle (θ) with respect to the row direction, the first angle (θ) satisfying the equation 40°≦|θ|≦70°.

6. The three-dimensional image display apparatus of claim 5, wherein:
the first distance (Ax) satisfies the equation Ax≦Px·cosθ; and
the second distance (Ay) satisfies the equation Ay≦Py·cosθ.

7. The three-dimensional image display apparatus of claim 1, wherein the spacers comprise:
main spacers that contact the first and second substrates; and
sub-spacers that contact one of the first and second substrates.

8. The three-dimensional image display apparatus of claim 7, wherein one of the main spacers and the sub-spacers are spaced apart in the row direction by the first distance (Ax) and spaced apart in the column direction at the second distance (Ay), the first distance (Ax) satisfying the equation 0.35Px≦Ax≦0.75Px, and the second distance (Ay) satisfying the equation 0.35Py≦Ay≦0.75Py.

9. The three-dimensional image display apparatus of claim 7, wherein one of the main spacers and the sub-spacers are arranged in the row direction at the first distance (Ax) and arranged in the column direction at the second distance (Ay), the first distance (Ax) satisfying the equation 1.35Px≦Ax, and the second distance (Ay) satisfying the equation 1.35 Py≦Ay.

10. The three-dimensional image display apparatus of claim 7, wherein:
a main arrangement direction of the main spacers is inclined at a first angle with respect to the row direction;
a main arrangement direction of the sub-spacers is inclined at a second angle with respect to the row direction; and
one of the first angle or the second angle satisfies the equation 40°≦|θ|≦70°.

11. The three-dimensional image display apparatus of claim 10, wherein:
one of the main spacers and the sub-spacers are arranged in each spacers' respective main arrangement directions separated by the first distance (Ax) and arranged in the column direction separated by the second distance (Ay);
the first distance (Ax) satisfying the equation Ax≦Px·cosθ; and
the second distance (Ay) satisfying the equation Ay≦Py·cosθ.

12. A three-dimensional image display apparatus comprising:
a display panel comprising pixels arranged in a row direction and a column direction; and
a switching panel configured to control liquid crystal molecules of the display panel, such that the display panel produces a two-dimensional image or a three-dimensional image, the switching panel comprising:
a first substrate;
a second substrate facing the first substrate; and
spacers interposed between the first and second substrates, wherein each of the pixels has a first width (Px), and a main arrangement direction of the spacers is inclined at a first angle (θ) with respect to the row direction, the spacers being spaced apart in the row direction at a first distance (Ax), wherein the first distance (Ax) satisfies the equation [{(n−1)/2}+0.5]Px<Ax1<[{(n−1)/2}+1]Px, “n” being a natural number equal to or greater than 1.

13. The three-dimensional image display apparatus of claim 12, wherein “n” is a number of viewpoints displayed by the switching panel.

14. The three-dimensional image display apparatus of claim 12, wherein the first angle (θ) satisfies the equation 8°≦θ≦10°.

15. The three-dimensional image display apparatus of claim 12, wherein a second distance (Ay) between the spacers on the main arrangement direction depends on a target density of the spacers in the switching panel.

16. The three-dimensional image display apparatus of claim 12, wherein the spacers comprise:
main spacers that contact the first and second substrates; and
sub-spacers that contact one of the first and second substrates.

17. The three-dimensional image display apparatus of claim 12, wherein a lower electrode is disposed on the first substrate and an upper electrode is disposed on the second substrate, the upper electrode comprising electrodes facing the lower electrode, extending in a direction inclined at the first angle, and being spaced apart from each other.

18. A three-dimensional image display apparatus comprising:
a display panel comprising pixels arranged in a row direction and a column direction; and
a switching panel configured to control liquid crystal molecules of the display panel, such that the display panel produces a two-dimensional image or a three-dimensional image, the switching panel comprising:
a first substrate;
a second substrate facing the first substrate; and
spacers interposed between the first and second substrates, wherein each of the pixel has a first width (Px) in the row direction and a second width (Py) in the column direction, the spacers being randomly spaced apart in a unit area, wherein the unit area (A1) satisfies the equation A1≧100(Px·Py).

19. The three-dimensional image display apparatus of claim 18, wherein the spacers comprise:
main spacers that contact the first and second substrates; and
sub-spacers that contact one of the first and second substrates, the sub-spacers being randomly arranged in the unit area.

20. The three-dimensional image display apparatus of claim 19, wherein a main arrangement direction of the main spacers is inclined at a first angle (θ) with respect to the column direction, the first angle (θ) satisfying the equation 8°≦θ≦10°.
